(19) United States
(12) Patent Application Publication
(10) Pub. No.: US 2014/0334604 A1
(43) Pub. Date: Nov. 13, 2014

(54) MICROSTRUCTURE, AND IMAGING APPARATUS HAVING THE MICROSTRUCTURE

(71) Applicant: CANON KABUSHIKI KAISHA, Tokyo (JP)

(72) Inventors: Takayuki Teshima, Yokohama-shi (JP); Takahisa Kato, Brookline, MA (US)

(21) Appl. No.: 14/362,361

(22) PCT Filed: Nov. 15, 2012
(86) PCT No.: PCT/JP2012/007337

§ 371 Date: Jun. 2, 2014

(30) Foreign Application Priority Data
Dec. 7, 2011 (JP) 2011-268215

(51) Int. Cl. G21K 1/10; G01N 23/20; G01N 23/04

(52) U.S. Cl. CPC G21K 1/10; G01N 23/04; G01N 23/20075
USPC 378/62; 378/154

(57) ABSTRACT

A microstructure includes a substrate, and a grating provided in the substrate and made of metal. The grating is provided with a plurality of holes. The plurality of holes are arranged in a first direction. In a plane containing the first direction, the maximum value of the distance between the center of gravity of a grating region composed of the grating and the plurality of holes and the outer edge of the grating region is less than 1.39 times the minimum value of the distance between the center of gravity of the grating region and the outer edge of the grating region.

### TECHNICAL FIELD

The present invention relates to a microstructure, and an imaging apparatus having the microstructure, and more specifically it relates to a microstructure, and an imaging apparatus having the microstructure used in an X-ray phase-contrast imaging apparatus.

### BACKGROUND ART

A diffraction grating composed of a microstructure having a periodic structure is used as a spectral element in various devices. In particular, a microstructure formed of metal having a high X-ray absorptance is used in nondestructive inspection of an object, and the medical field.

One of the applications of a microstructure formed of metal having a high X-ray absorptance is a shield grating of an imaging apparatus that performs an imaging method using Talbot interference of X-rays (X-ray Talbot interferometry).

The X-ray Talbot interferometry will be described briefly. The X-ray Talbot interferometry is one of imaging methods (X-ray phase imaging methods) utilizing the phase contrast of X-rays.

In a general imaging apparatus that performs the X-ray Talbot interferometry, spatially coherent X-rays pass through a subject and a diffraction grating that diffracts X-rays and forms an interference pattern. At a position where the interference pattern is formed, a shield grating that periodically shields against X-rays is disposed, and moire is formed. This moire is detected by a detector. Using the detection result, an imaged image (in general, a phase image, a differential phase image, or a scattering image) is obtained.

A general shield grating used in the Talbot interference method has a structure in which X-ray transmitting portions (hereinafter also simply referred to as “transmitting portions”) and X-ray shielding portions (hereinafter also simply referred to as “shielding portions”) are periodically arranged. The X-ray shielding portions are often formed so as to have a high aspect ratio structure (“aspect ratio” is defined as the ratio of the height or depth h to the width w of a structure (h/w)). A planar shield grating is effective in the case where parallel light (parallel X-rays) is dealt with, for example, in facilities for synchrotron radiation. However, in the case of imaging using a point X-ray source that emits divergent light (divergent X-rays), such as an X-ray tube, in a laboratory, the difference between the direction in which X-rays travel and the height direction of the shielding portions increases with increasing distance from the optical axis (X-ray axis). Therefore, even X-rays desired to be transmitted by the shield grating are blocked, sufficient transmission contrast of X-rays cannot be obtained, and the amount of X-rays that reach the detector decreases. Therefore, there is a possibility that in a peripheral region distant from the optical axis, the contrast of the obtained imaged image may decrease, or the imaged image itself cannot be obtained.

PTL 1 discloses a method for making the height direction of the shielding portions the same direction as the direction in which X-rays travel, the method including sealing a shield grating in a vacuum chamber having a circular frame, and two-dimensionally curving the shield grating into a shape of a spherical cap by exerting pressure difference.

In order to reduce the difference between the direction in which X-rays travel and the height direction of the shielding portions, it is desirable to curve the grating into a shape conforming with the wavefront of the divergent X-rays. “A shape conforming with the wavefront of two-dimensionally divergent X-rays” is a concentrically curved shape. “Concentric curvature” is such a curvature that the amounts of curvature at positions equally distant in various directions from the center of gravity of the grating region are equal. However, in the method disclosed in PTL 1, depending on the shape of the outer edge of the grating region, the distribution of the bending strength of the grating is sometimes not concentric relative to the center of gravity of grating. For this reason, it is sometimes difficult to concentrically curve the grating. For example, in the case where the outer edge of the grating region is quadrilateral, the bending strength in the horizontal direction is different from that in the diagonal direction, and therefore such a grating is difficult to concentrically curve.

### CITATION LIST

### Patent Literature

PTL 1: Japanese Patent Laid-Open No. 2007-206075 (corresponding to U.S. Pat. No. 7,486,770)

### SUMMARY OF INVENTION

The present invention provides a microstructure that is easier to concentrically curve than microstructures conventionally used as shield gratings.

Further features of the present invention will become apparent from the following description of exemplary embodiments with reference to the attached drawings.

### BRIEF DESCRIPTION OF DRAWINGS

FIG. 1A is a sectional view schematically showing a microstructure of an embodiment of the present invention.

FIG. 1B is a top view schematically showing the microstructure of the embodiment of the present invention.

FIG. 2A is a graph illustrating the embodiment of the present invention.

FIG. 2B is a graph illustrating the embodiment of the present invention.

FIG. 2C is a top view of a microstructure relating to the graph of FIG. 2A.

FIG. 2D is a top view of a microstructure relating to the graph of FIG. 2B.

FIG. 3 is a graph illustrating the embodiment of the present invention.

FIG. 4A is a process drawing showing a method for manufacturing a microstructure of example 1 of the present invention.

FIG. 4B is a process drawing showing the method for manufacturing the microstructure of example 1 of the present invention.

FIG. 4C is a process drawing showing the method for manufacturing the microstructure of example 1 of the present invention.

FIG. 4D is a process drawing showing the method for manufacturing the microstructure of example 1 of the present invention.

FIG. 5 is a diagram illustrating example 4 of the present invention.

FIG. 6 is a configuration diagram showing an embodiment of an imaging apparatus having a microstructure of the embodiment or any one of the examples of the present invention.

FIG. 7 is a top view of a conventional microstructure.

### DESCRIPTION OF EMBODIMENT

An embodiment of the present invention will be described in detail below.

### Embodiment

A microstructure according to the embodiment of the present invention has the following characteristics.

The microstructure according to this embodiment has a substrate, and a grating provided in the substrate and made of metal. The grating made of metal is provided with a plurality of holes, which are arranged in a first direction.

In a plane containing the first direction, the maximum value of the distance between the center of gravity of the grating region and the outer edge of the grating region is less than 1.39 times the minimum value of the distance between the center of gravity of the grating region and the outer edge of the grating region.

“Grating region” is a region composed of a grating made of metal, and a plurality of holes provided in the grating. “The center of gravity of a grating region in a plane” means the point of intersection of a line passing through the center of gravity of the grating and perpendicular to the plane, with the plane. The “center of gravity of a grating” is the center of gravity of the grating region when the thickness of the grating is uniform in the grating region.

For example, in the case where the outer edge of a grating region is circular, the center of gravity of the grating region in a plane containing the first direction coincides with the center of the circle in the plane containing the first direction.

The plurality of holes provided in the grating do not necessarily need to be voids. For example, if the holes are filled with silicon or resin, they are deemed to be holes. In the case where a grating has a one-dimensional array, the grating has such a structure that a plurality of metal structures are aligned in the substrate. In this case, the regions between the metal structures are deemed to be holes, and the grating is deemed to have a plurality of holes.

The microstructure of this embodiment can be used as a shield grating that shields against some of divergent X-rays. In addition, since X-ray transmitting portions and X-ray shielding portions can be arranged at small pitches, the microstructure of this embodiment can be used as a shield grating used in an imaging apparatus that performs the X-ray Talbot interferometry.

The embodiment of the present invention will be described below with reference to the drawings.

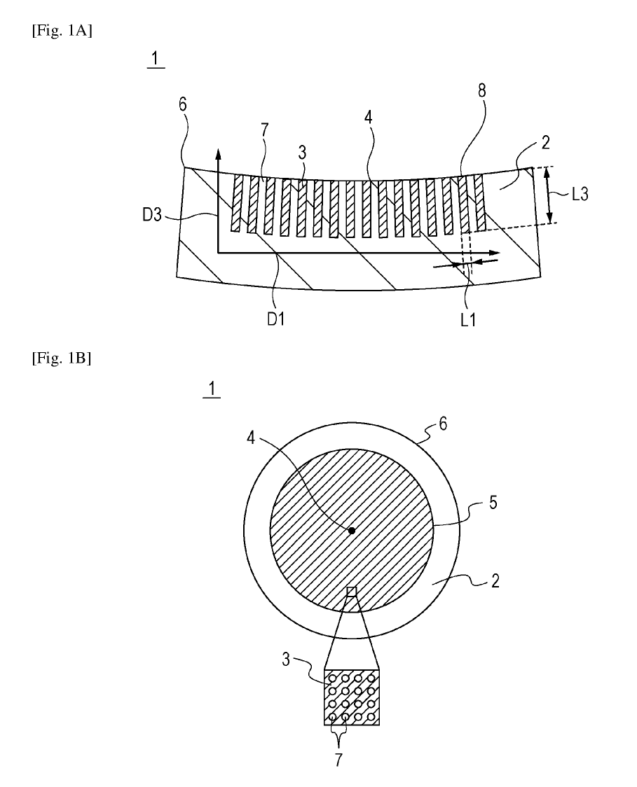

A microstructure 1 will be described with reference to FIG. 1A and FIG. 1B. FIG. 1A is a sectional view of the microstructure 1, and FIG. 1B is a top view of the microstructure 1. A grating 3 is provided with a plurality of holes 7, which are arranged in a first direction, and a second direction intersecting with the first direction. Since the plurality of holes 7 are arranged in this manner, the grating 3 has a two-dimensional array. Although in the microstructure 1 shown in FIG. 1A and FIG. 1B, the plurality of holes 7 are arranged in the first direction and the second direction, the plurality of holes 7 may be arranged only in the first direction. In this case, the grating has a one-dimensional array. When these microstructures are used as X-ray shield gratings, the grating functions as X-ray shielding portions and the plurality of holes function as X-ray transmitting portions. Therefore, a microstructure having a grating having a two-dimensional array can be used as a two-dimensional shield grating. A microstructure having a grating having a one-dimensional array can be used as a one-dimensional shield grating.

In the case where the microstructure 1 of this embodiment is used as an X-ray shield grating as described above, the grating functions as shielding portions and the plurality of holes function as transmitting portions. Therefore, the material forming the holes needs to have an X-ray transmittance higher than that of the material forming the grating. When the holes are voids, it is deemed that air forms the holes. In the case where as shown in FIG. 1A, parts of the substrate 2 form the holes provided in the grating, the material of the substrate 2 is selected from materials having an X-ray transmittance higher than that of the metal material of the grating. Examples of materials having a high X-ray transmittance include silicon, quartz, glass, and resin. The substrate 2 may include a part formed of a material having a low X-ray transmittance as long as the part is out of the imaging range when the microstructure 1 is installed in an imaging apparatus. Examples of metal materials usable for the grating include precious metals such as gold, silver, platinum, rhodium, and palladium, and other metals such as copper, nickel, chromium, tin, iron, cobalt, zinc, tungsten, and bismuth, and alloys of these metals.

In particular, gold, gold alloy, tungsten, and the like, which have a low X-ray absorptance, are desirably used as the metal material of the grating because when the microstructure 1 is used as an X-ray shield grating, the aspect ratio of the shielding portions can be kept low. The aspect ratio of the shielding portions is the ratio of L3 to L1 of a region 8 of the grating between two adjacent holes arranged in the first direction D1, where L1 is the length in the first direction, and L3 is the length in a third direction D3 perpendicular to each of the first direction and the second direction. The length in the third direction is the length of the grating, and does not include the length of the substrate even if the substrate is present under the grating. The length in the third direction corresponds to the depth of the holes provided in the grating. In the case where the microstructure according to this embodiment is used as a shield grating that shields against some of divergent X-rays, the length of the shielding portions in the third direction (the depth of the holes) can be suitably determined according to the material of the grating, the energy of X-rays desired to be blocked, and the desired shielding ratio. The pitch of the plurality of holes can also be suitably determined, and therefore the aspect ratio of the shielding portions can be suitably determined from these. In the case where the microstructure according to this embodiment is used as a shield grating used in the X-ray Talbot interferometry, the shielding portions and the transmitting portions need to be arranged at small pitches, and therefore the aspect ratio is desirably 5 or more. The higher the aspect ratio, the more difficult the manufacturing. Therefore, the aspect ratio is desirably 100 or less.

In this embodiment, the difference between the maximum value of the distance between the center 4 of gravity of the grating region and the outer edge 5 of the grating region and the minimum value of the distance between the center 4 of gravity of the grating region and the outer edge 5 of the grating region in a plane containing the first direction in which the plurality of holes are arranged (hereinafter also referred to as “cross-section,” however, this plane does not necessarily need to be a cross-section of the microstructure, and may be, for example, the top surface) is reduced in order to make the microstructure 1 easy to curve into a nearly concentric shape. Unless otherwise noted, “the center of gravity of the grating region” is the center of gravity in the cross-section, and “the outer edge of the grating region” is the outer edge in the cross-section. “Close to concentric” includes concentric.

By reducing the difference between the maximum value of the distance between the center 4 of gravity of the grating region and the outer edge 5 of the grating region and the minimum value of the distance between the center 4 of gravity of the grating region and the outer edge 5 of the grating region, the distribution of the bending strength of the grating is approximated to a distribution concentric relative to the center of gravity of the grating, and therefore the grating becomes easy to curve into a nearly concentric shape.

In the case where the microstructure 1 is manufactured by filling a mold with metal using plating, the warping of the grating is caused to occur by tensile stress generated by plating. In the case of a grating having a two-dimensional array, the distribution of the amount of this warping (hereinafter referred to as the amount of warping) is also approximated to a concentric distribution by reducing the difference between the maximum value of the distance between the center 4 of gravity of the grating region and the outer edge 5 of the grating region and the minimum value of the distance between the center 4 of gravity of the grating region and the outer edge 5 of the grating region. As the distribution of the amount of warping is approximated to a concentric distribution, the shape of the curvature of the grating caused by tensile stress is also approximated to a concentric shape. For this reason, when the microstructure according to this embodiment is used as a shield grating, the difference between the direction in which X-rays travel and the height direction of the shielding portions is small even in the peripheral region distant from the X-ray axis. Depending on the distribution of the bending strength, the difference between the direction in which X-rays travel and the height direction of the shielding portions may become negligibly small without the application of an external force to the grating. If a microstructure curves concentrically without the application of an external force, the grating is “easy to concentrically curve” in this specification.

In the case where an external force is applied to the grating, the grating is easy to curve into a nearly concentric shape since the distribution of the bending strength approximates to a concentric distribution. For this reason, it is easy to apply an external force such that the difference between the direction in which X-rays travel and the height direction of the shielding portions in the peripheral region distant from the X-ray axis is reduced. “The difference between the direction in which X-rays travel and the height direction of the shielding portions is small” means that the width of the X-ray beam just after passing through the transmitting portion is at least about half the width of the transmitting portion. When the difference between the direction in which X-rays travel and the height direction of the shielding portions is negligibly small, the width of the X-ray beam just after passing through the transmitting portion is approximately equal to the width of the transmitting portion.

In this embodiment, the maximum value of the distance between the center 4 of gravity of the grating region and the outer edge 5 of the grating region is less than 1.39 times the minimum value of the distance between the center 4 of gravity of the grating region and the outer edge 5 of the grating region. When the outer edge of the grating region has such a shape, the distribution of the bending strength of grating is nearly concentric, and therefore the grating is easy to concentrically curve.

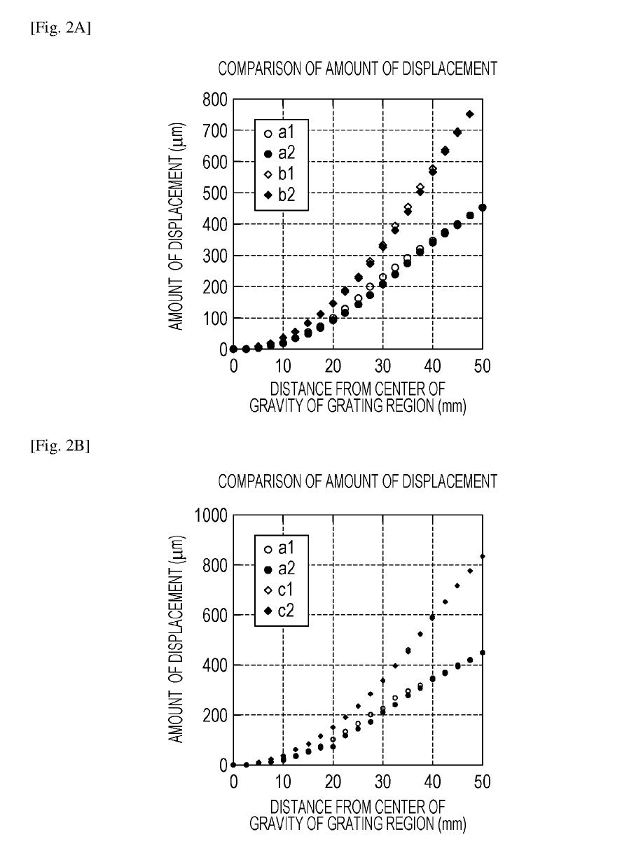

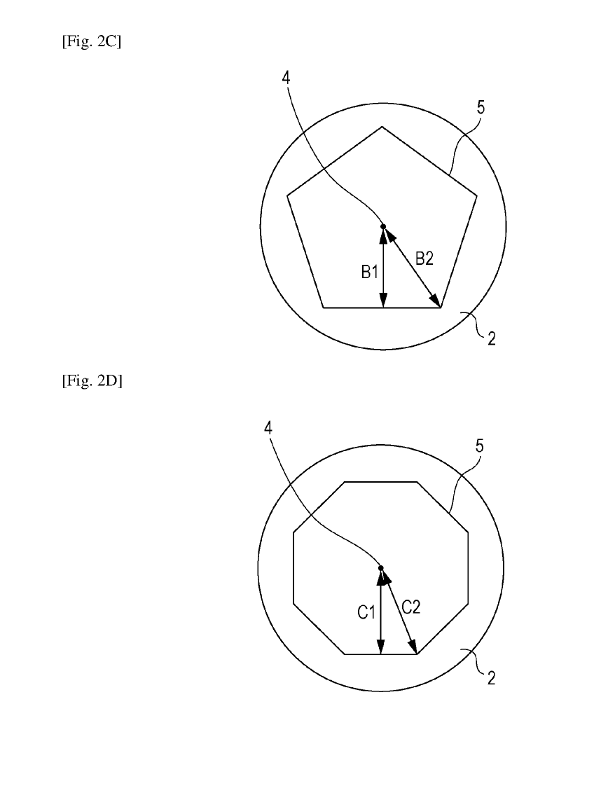

A gold plated layer having a thickness of 120 micrometers and a tensile stress of 100 MPa was formed on a silicon wafer having a thickness of 525 micrometers, and the amount of displacement in the Z direction (direction perpendicular to the wafer) was measured from the center of gravity of the grating region toward the outer edge. FIG. 2A and FIG. 2B are graphs showing the measurements. The amount of displacement in the Z direction will hereinafter be referred to as the amount of warping. In the case of this microstructure, the silicon wafer serves as a substrate, and the gold plated layer serves as a grating.

FIG. 2A is a graph showing the relationship between the distance from the center of gravity of the grating region and the amount of warping in the Z direction in the microstructures shown in FIG. 7 and FIG. 2C.

a1 and a2 represent the amount of warping in the Z direction, in a direction A1 and a direction A2 in which the distance between the center 4 of gravity and the outer edge 5 of the grating region shows the minimum value and the maximum value, respectively, in the microstructure shown in FIG. 7 having a grating region whose outer edge 5 is square, 50 mm on a side. In the microstructure shown in FIG. 7, the maximum value of the distance between the center 4 of gravity of the grating region and the outer edge 5 of the grating region is 1.41 times the minimum value of the distance between the center 4 of gravity of the grating region and the outer edge 5 of the grating region. The grating region of a microstructure used as a general shield grating is square as shown in FIG. 7, and FIG. 7 shows a comparative example.

b1 represents the amount of warping in the Z direction, in a direction B1 in which the distance between the center 4 of gravity of the grating region and the outer edge 5 of the grating region shows the minimum value, in the regular pentagonal microstructure shown in FIG. 2C in which a square 50 mm on a side is inscribed in the outer edge 5 of the grating region. Similarly, b2 represents the amount of warping in the Z direction, in a direction B2 in which the distance between the center 4 of gravity of the grating region and the outer edge 5 of the grating region shows the maximum value, in the microstructure shown in FIG. 2C. In the microstructure shown in FIG. 2C, the maximum value of the distance between the center 4 of gravity of the grating region and the outer edge 5 of the grating region is 1.23 times the minimum value of the distance between the center 4 of gravity of the grating region and the outer edge 5 of the grating region.

FIG. 2A shows that when the distance from the center of gravity of the grating region is 20 to 40 mm, there is a difference between the amount of warping a1 in the direction A1 and the amount of warping a2 in the direction A2. The difference between the amount of warping b1 in the direction B1 and the amount of warping b2 in the direction B2 is smaller than the difference between the amount of warping a1 in the direction A1 and the amount of warping a2 in the direction A2. Therefore, in the microstructure shown in FIG. 2C, the distribution of the amount of warping from the center of gravity of the grating region to the outer edge is closer to a concentric distribution than in the microstructure shown in FIG. 7, and therefore the microstructure shown in FIG. 2C is easier to concentrically curve than the microstructure shown in FIG. 7.

FIG. 2B is a graph showing the relationship between the distance from the center of gravity of the grating region and the amount of warping in the microstructures shown in FIG. 7 and FIG. 2D.

a1 and a2 are the same as those in FIG. 2A. c1 represents the amount of warping in a direction Cl in which the distance between the center 4 of gravity of the grating region and the outer edge 5 of the grating region shows the minimum value, in the regular octagonal microstructure shown in FIG. 2D in which a square 50 mm on a side is inscribed in the outer edge 5 of the grating region. Similarly, c2 represents the amount of warping in a direction C2 in which the distance between the center 4 of gravity of the grating region and the outer edge 5 of the grating region shows the maximum value, in the microstructure shown in FIG. 2D. In the microstructure shown in FIG. 2D, the maximum value of the distance between the center 4 of gravity of the grating region and the outer edge 5 of the grating region is 1.09 times the minimum value of the distance between the center 4 of gravity of the grating region and the outer edge 5 of the grating region.

FIG. 2B shows that, as in FIG. 2A, the difference between the amount of warping cl in the direction Cl and the amount of warping c2 in the direction C2 is smaller than the difference between the amount of warping a1 in the direction A1 and the amount of warping a2 in the direction A2. Therefore, in the microstructure shown in FIG. 2D, the distribution of the amount of warping from the center of gravity of the grating region to the outer edge is closer to a concentric distribution than in the microstructure shown in FIG. 7, and therefore the microstructure shown in FIG. 2D is easier to concentrically curve than the microstructure shown in FIG. 7.

FIG. 3 is a graph showing the relationship between the ratio of the difference in the amount of warping to the maximum amount of warping and the variation in the distance between the center 4 of gravity of the grating region and the outer edge 5 of the grating region at a place at a distance of 25 mm from the center 4 of gravity of the grating region, calculated from the data of FIG. 2A and FIG. 2B. The horizontal axis shows the quotient of the maximum value divided by the minimum value of the distance between the center 4 of gravity of the grating region and the outer edge 5 of the grating region. The vertical axis shows the ratio of the difference in the amount of warping at a place at a distance of 25 mm from the center 4 of gravity of the grating region to the maximum amount of warping at a place at a distance of 25 mm from the center 4 of gravity of the grating region. The difference in the amount of warping is the difference between the amount of warping (a1, b1, c1) in the direction (A1, B1, C1) in which the distance between the center of gravity of the grating region and the outer edge of the grating region shows the minimum value, and the amount of warping (a2, b2, c2) in the direction (A2, B2, C2) in which the distance between the center of gravity of the grating region and the outer edge of the grating region shows the maximum value.

FIG. 3 shows that when the maximum value of the distance between the center 4 of gravity of the grating region and the outer edge 5 of the grating region is less than 1.39 times the minimum value, the difference in the amount of warping equidistant (25 mm) from the center 4 of gravity of the grating region is less than or equal to 10% of the maximum amount of warping at that distance. FIG. 3 also shows that when the maximum value of the distance between the center 4 of gravity of the grating region and the outer edge 5 of the grating region is less than or equal to 1.33 times the minimum value, the difference in the amount of warping equidistant from the center 4 of gravity of the grating region is less than or equal to 5% of the maximum amount of warping at that distance. FIG. 3 also shows that when the maximum value of the distance between the center 4 of gravity of the grating region and the outer edge 5 of the grating region is less than 1.25 times the minimum value, the difference in the amount of warping equidistant from the center 4 of gravity of the grating region is less than 2% of the maximum amount of warping at that distance.

Therefore, in order to make the difference in the amount of warping equidistant from the center 4 of gravity of the grating region less than or equal to 10% of the maximum amount of warping, the maximum value/minimum value of the distance between the center 4 of gravity of the grating region and the outer edge 5 of the grating region needs to be less than or equal to 1.39. Similarly, in order to make the difference in the amount of warping equidistant from the center 4 of gravity of the grating region less than or equal to 5% of the maximum amount of warping, the maximum value/minimum value needs to be less than or equal to 1.33. In order to make the difference in the amount of warping equidistant from the center 4 of gravity of the grating region less than or equal to 2% of the maximum amount of warping, the maximum value/minimum value needs to be less than or equal to 1.25. By reducing the maximum value/minimum value, the distribution of the amount of warping from the center 4 of gravity of the grating region to the outer edge is approximated to a concentric distribution, and the curvature of the grating caused by warping is approximated to a concentric curvature.

When the outer edge 5 of the grating region is circular, the distance from the center 4 of gravity of the grating region to the outer edge 5 of the grating region is equal in any direction. That is to say, the maximum value of the distance from the center 4 of gravity of the grating region to the outer edge 5 of the grating region is equal to the minimum value thereof, the distribution of the amount of warping from the center 4 of gravity of the grating region to the outer edge is concentric, and the curvature of the microstructure 1 caused by warping is also concentric. Therefore, it is especially desirable that the outer edge of the grating region be circular.

In the case where the grating is manufactured without using plating and the warping due to tensile stress is suppressed, the distribution of the bending strength is close to a concentric distribution. Therefore, making the maximum value/minimum value of the distance between the center 4 of gravity of the grating region and the outer edge 5 of the grating region less than or equal to 1.39 makes the grating easy to concentrically curve. Similarly, making the maximum value/minimum value less than or equal to 1.33 makes the grating easier to concentrically curve, and making the maximum value/minimum value less than or equal to 1.25 makes the grating much easier to concentrically curve. In addition, since the distribution of the bending strength is concentric when the outer edge 5 of the grating region is circular, it is especially desirable that the outer edge of the grating region be circular.

In the case where the shape of curvature obtained by warping is different from the desired shape of curvature, an external force may be applied to the grating 3 in order to curve into the desired shape. Also in the case where an external force is applied, the grating is easy to concentrically curve when the difference between the maximum value and minimum value of the distance between the center 4 of gravity of the grating region and the outer edge 5 of the grating region is small, since the distribution of the amount of warping is close to a concentric distribution, and the distribution of the bending strength of the grating region is also close to a concentric distribution. The distribution of the bending strength of the grating region can be approximated to a concentric distribution also in the case where the grating is manufactured by a method in which tensile stress is not generated.

The above description is based on the assumption that the substrate has no effect on the amount of warping and the bending strength of the grating. Actually, if the substrate is deformed in response to the warping of the grating caused by the tensile stress of the grating, a stress is generated in the substrate at the time of the deformation and may have an effect on the amount of warping of the grating. Even if the grating is manufactured such that tensile stress is not generated, the substrate may have an effect on the amount of warping of the grating. The effects of the substrate vary depending on the material of the substrate and the relationship between the size of the grating region and the size of the substrate, and are sometimes negligibly small. However, it is desirable that the outer edge 5 of the grating region and the outer edge of the substrate are similar to each other. This improves the uniformity of the distance from the outer edge of the grating region to the outer edge of the substrate. The improvement in the uniformity of the distance from the outer edge 5 of the grating region to the outer edge 6 of the substrate improves the uniformity of the stress in the circumferential direction of the substrate generated at the time of the deformation of the substrate due to the stress generated from the grating. Therefore, even in the case where the substrate has a significant effect on the amount of warping of the grating, the distribution of the amount of warping from the center of gravity of the grating region to the outer edge is easily approximated to a concentric distribution. In the case where the grating is manufactured such that tensile stress is not generated, the improvement in the uniformity of the distance from the outer edge 5 of the grating region to the outer edge 6 of the substrate makes it easy to approximate the distribution of bending strength to a concentric distribution.

It is desirable that the center of gravity of the grating region coincides with the center of gravity of the substrate in cross-section. “The center of gravity of the substrate in cross-section” means the point of intersection of a line passing through the center of gravity of the substrate and perpendicular to the cross-section, with the cross-section. “The center of gravity of the substrate” is the center of gravity of the substrate when the thickness of the substrate is uniform. For example, if the substrate is circular or doughnut-shaped, the center of gravity of the substrate coincides with its center.

When the center of gravity of the grating region coincides with the center of gravity of the substrate, the symmetry of the microstructure 1 is improved, and the symmetry of the deformation of the substrate due to the stress generated from the grating is improved. Therefore, even in the case where the substrate has a significant effect on the amount of warping of the grating, the distribution of the amount of warping from the center 4 of gravity of the grating region to the outer edge is easily approximated to a concentric distribution. In the case where the grating is manufactured such that tensile stress is not generated, the distribution of bending strength is easily approximated to a concentric distribution. If the center of gravity of the grating region is misaligned by about 1 mm from the center of gravity of the substrate, this is deemed to be within the error range, and it is deemed that the center of gravity of the grating region coincides with the center of gravity of the substrate. However, this error is desirably small.

The microstructure 1 of this embodiment can be manufactured by filling a mold by plating. A mold made of photoresist can be formed by forming a photoresist layer on a substrate 2 having a conductive surface and then performing semiconductor photolithography. Alternatively, recesses may be formed in the substrate 2 by semi-conductor photolithography and etching, and this substrate may be used as a mold. The method for manufacturing a mold is not limited to these. In the case where a grating formed by filling a mold by plating is used as a microstructure, the mold corresponds to a substrate. After filling the mold by plating to form a grating, part or all of the mold may be removed. If only parts of the mold that form the plurality of holes provided in the grating are removed, the X-ray transmittance of the X-ray transmitting portions can be improved while keeping the strength of the microstructure. As described above, if part of the mold is removed, the mold remains the substrate of the microstructure. The grating from which the mold is removed may be newly provided with a substrate made of silicon, resin, or the like, for reinforcement and ease of installation in an X-ray imaging apparatus. For example, the grating from which all of the mold is removed may be surrounded with a substrate for reinforcement and ease of installation in an X-ray imaging apparatus. In the case where the grating region is circular, and the grating region is surrounded with a substrate, the substrate is doughnut-shaped. The substrate can have such a shape, and also in this case, the grating is deemed to be provided in the substrate.

If a grating from which all of the mold is removed and that is curved due to tensile stress is provided with a substrate, the grating is curved but the substrate is not curved. However, if the grating is curved, the grating is desirable as a shield grating that shields against divergent X-rays.

The method for manufacturing the microstructure 1 of this embodiment is not limited to these. For example, the grating may be manufactured without using plating. In this case, the occurrence of warping due to the tensile stress of the grating is suppressed. Also in this case, the grating is made easy to concentrically curve by reducing the difference between the maximum value and minimum value of the distance between the center 4 of gravity of the grating region and the outer edge 5 of the grating region.

A case where the microstructure shown in FIG. 1A and FIG. 1B is used as a shield grating of an imaging apparatus that performs the X-ray Talbot interferometry will be described.

The microstructure 1 has a substrate 2, and a grating 3 provided in the substrate 2 and made of metal. The metal forming the grating is a material having a high X-ray absorption coefficient, and this grating region is circular. The microstructure 1 is curved concentrically from the center 4 of gravity of the grating region to the outer edge 5 of the grating region, and has a shape of a spherical cap. When the microstructure 1 of FIG. 1A and FIG. 1B is used as a shield grating, the grating region functions as X-ray shielding portions, and the plurality of holes provided in the grating function as X-ray transmitting portions. Since the microstructure 1 is curved from the center 4 of gravity of the grating region to the outer edge 5 of the grating region, the increase in the difference between the direction in which X-rays travel and the height direction of the X-ray shielding portions with increasing distance from the optical axis is avoided in imaging using a point X-ray source. Thus, X-rays easily pass through the microstructure, and therefore the X-ray transmission contrast is improved.

The applications of this embodiment are not limited to this. This embodiment can also be used, for example, as an X-ray source grating that is disposed between an X-ray source and a diffraction grating of an imaging apparatus that performs the X-ray Talbot interferometry, and that periodically shields against X-rays and thereby virtually produces a state where point light sources are arranged. This embodiment can also be used in an imaging apparatus that does not perform the X-ray Talbot interferometry, and can also be used for purposes other than for use in an imaging apparatus. The microstructure 1 of this embodiment is relatively easy to concentrically curve, and is therefore useful, for example, for an apparatus that needs a grating curved so as to conform with the wavefront of divergent X-rays.

### EXAMPLES

The present invention will be described in more detail below with specific examples.

### Example 1

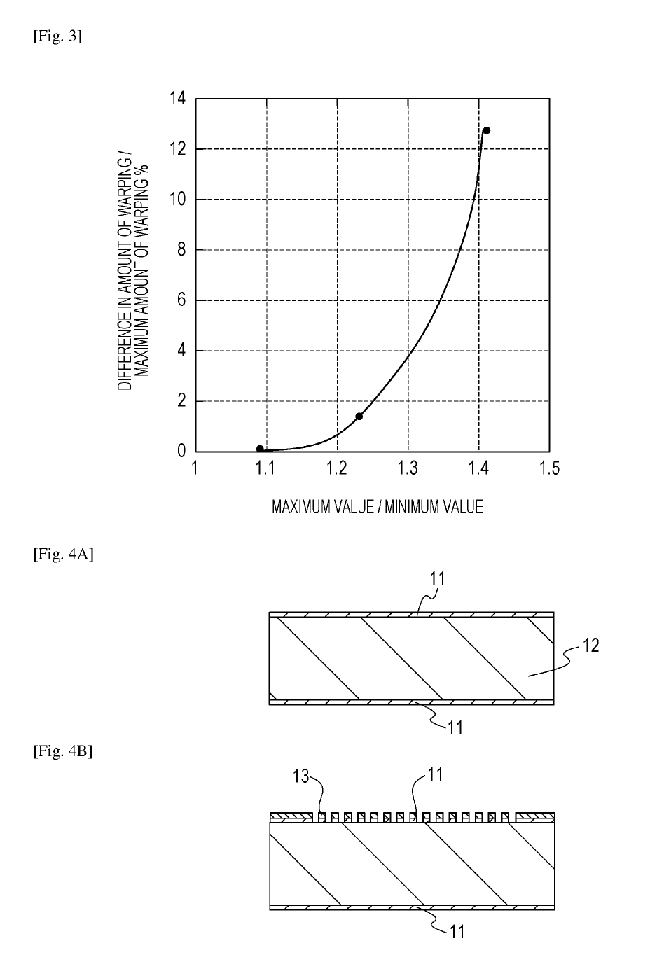

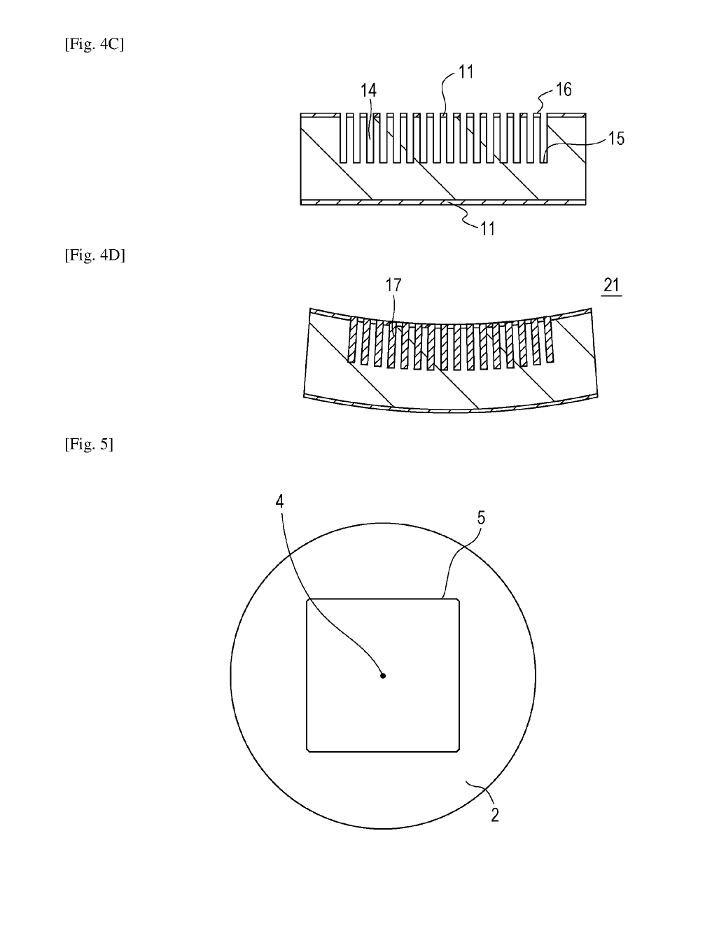

In this example, such a microstructure that a grating made of gold is formed on a circular silicon substrate will be described. The outer edge of the grating region of this microstructure is circular. A method for manufacturing the microstructure of this example will be described with reference to FIG. 4A to FIG. 4D.

A circular silicon substrate 100 mm in diameter, 525 micrometers in thickness, and 0.02 ohm centimeter in resistivity is used as a substrate. By thermally oxidizing the silicon substrate 12 at 1050 degrees Celsius for 75 minutes, an thermally oxidized film 11 about 0.5 micrometers thick is formed on each side of the silicon substrate (FIG. 4A).

A chromium film 200 nm thick is formed only on one side of the substrate with an electron beam evaporation apparatus. A positive resist is applied thereon, and patterning is performed by semiconductor photolithography such that resist dots 4 micrometers in diameter are disposed two-dimensionally at a pitch of 8 micrometers in a region 71 mm in diameter. At this time, the center of the region 71 mm in diameter in which is aligned with the center of gravity of the silicon substrate. Subsequently, the chromium is etched with a chromium etching aqueous solution, and then the thermally oxidized film is etched by reactive etching using CHF3. Thus, a pattern is formed in which chromium dots 4 micrometers in diameter are arranged two-dimensionally at a pitch of 8 micrometers on a silicon exposed surface 71 mm in diameter (FIG. 4B). In this example, this chromium mask 13 is used as an etching mask.

Subsequently, deep anisotropic etching is performed on the exposed silicon by ICP-RIE. The deep etching is stopped when the etching progresses to a depth of about 125 micrometers. As a result, a plurality of recesses 14 about 125 micrometers in depth are formed in the silicon substrate (FIG. 4C).

Subsequently, the resist and the chromium are removed by UV ozone ashing in a chromium etching aqueous solution. The substrate is cleaned with a mixture of sulfuric acid and hydrogen peroxide solution, is washed with water, and is then dried.

Next, by thermal oxidation at 1050 degrees Celsius for 7 minutes, a thermally oxidized film about 0.1 micrometer thick is formed on the surface of the silicon substrate 12 in which recesses are formed by the above deep etching.

Next, dry etching using CHF3 plasma is performed. This etching has high anisotropy, and progresses nearly vertically relative to the substrate. Therefore, while the thermally oxidized films at the bottoms 15 of the recesses of the silicon substrate are removed, the thermally oxidized films on the sidewalls of the recesses 14 remain.

Next, a layer of chromium about 7.5 nm thick and a layer of copper about 50 nm thick are formed in this order with an electron beam evaporation apparatus. Thus, a seed electrode layer made of chromium and copper is formed on the exposed surface of silicon. Since electron beam evaporation is a highly directional evaporation method, films are formed at the bottoms 15 of the recesses and on the top surfaces 16 of the recesses.

Next, part of the thermally oxidized film on the periphery of the silicon substrate is removed to expose the silicon surface. Using the exposed silicon surface as a lead-out electrode for plating, and using the substrate as a mold, the recesses 14 are filled with metal by plating.

In this example, gold is used as metal. Using gold plating solution MICROFAB Aul101 (manufactured by Electroplating Engineers of Japan Ltd.), a gold plated layer having a tensile stress of 100 MPa is formed.

The silicon substrate is immersed in a gold plating solution, and energization is performed at 60 degrees Celsius at a current density of 0.2 A/dm2 for 24 hours, with the lead-out electrode of the exposed silicon surface serving as a cathode, to form a gold plated layer 17 to a height of 120 micrometers from the bottoms 15 of the recesses. Thus, a microstructure 21 is obtained in which a grating made of gold is formed in a region 71 mm in diameter on a silicon substrate. The grating made of gold has a plurality of holes, which are made of silicon. The plurality of holes made of silicon are arranged two-dimensionally. If these array directions are referred to as a first direction and a second direction, the outer edge of the grating region is circular in a plane containing the first direction and the second direction. That is, there is no variation in the distance between the center of gravity of the grating region and the outer edge of the grating region, and the maximum value and the minimum value are equal to each other. In a plane having the first direction and the second direction, the center of gravity of the grating region coincides with the center of gravity of the substrate. This microstructure has a distribution of the amount of warping that is concentric from the center of gravity of the grating region to the outer edge of the grating region, and curves in a shape of a spherical cap. The amount of warping at a distance of 35 mm from the center of gravity of the grating region is 302 micrometers, and therefore the curvature radius of this microstructure is 0.5 m. Since the length in the first direction of a region between two holes arranged in the first direction is 4 micrometers, and the length in a third direction perpendicular to each of the first direction and the second direction is 120 micrometers, the aspect ratio of the shielding portions is 120 micrometers/4 micrometers=30.

### Comparative Example 1

This comparative example is the same as the microstructure of example 1 except that the outer edge of the grating region is a square 50 mm on a side, and is made by the same method as example 1. In this comparative example, the maximum value of the distance between the center of gravity of the grating region and the outer edge of the grating region (the distance in the direction A2 of FIG. 7) is 35.5 mm, and the minimum value (the distance in the direction A1 of FIG. 7) is 25 mm Therefore, the maximum value of the distance between the center of gravity of the grating region and the outer edge of the grating region is 1.41 times the minimum value. The amount of warping at a point 25 mm distant from the center of gravity of the grating region, in such a direction that the distance from the center of gravity of the grating region to the outer edge of the grating region is maximum, is 146 micrometers. On the other hand, the amount of warping at a point 25 mm distant from the center of gravity of the grating region, in such a direction that the distance from the center of gravity of the grating region to the outer edge of the grating region is minimum, is 164 micrometers. The difference in the amount of warping at a point 25 mm from the center of gravity between the direction of the maximum value and the direction of the minimum value is 18 micrometers. This difference in the amount of warping is equivalent to about 11% of the maximum amount of warping (164 micrometers) at a point 25 mm distant from the center of gravity of the grating region.

### Example 2

This example is the same as the microstructure of example 1 except that the outer edge of the grating region is a regular pentagon 47 8 mm on a side, and is made by the same method as example 1. In the microstructure of this example, the maximum value of the distance between the center of gravity of the grating region and the outer edge of the grating region (corresponding to the distance in the direction B2 of FIG. 2C) is 40.6 mm, and the minimum value (corresponding to the distance in the direction B1 of FIG. 2C) is 32.9 mm Therefore, the maximum value of the distance between the center of gravity of the grating region and the outer edge of the grating region is 1.23 times the minimum value. The amount of warping at a point 25 mm distant from the center of gravity of the grating region, in such a direction that the distance from the center of gravity of the grating region to the outer edge of the grating region is maximum, is 229 micrometers. On the other hand, the amount of warping at a point 25 mm distant from the center of gravity of the grating region, in such a direction that the distance from the center of gravity of the grating region to the outer edge of the grating region is minimum, is 233 micrometers. The difference in the amount of warping at a point 25 mm from the center of gravity between the direction of the maximum value and the direction of the minimum value is 4 micrometers. This difference in the amount of warping is about 1.7% of the maximum amount of warping (233 micrometers) at a point 25 mm distant from the center of gravity of the grating region.

### Example 3

This example is a microstructure having a grating region whose outer edge is a regular octagon 29 4 mm on a side, and made by using a resin layer formed on a substrate as a mold, and filling the mold with gold by plating.

A method for making this example will be described. In this example, a silicon substrate is used as a substrate. A chromium layer 5 nm thick and a copper layer 100 nm thick are formed in this order as a conductive layer on a silicon substrate having an orientation flat length of 32.5 mm, a diameter of 100 mm, and a thickness of 525 micrometers with an electron beam evaporation apparatus. Patterning is performed using negative resist SU-8 (manufactured by KAYAKU Micro Chemical Co., Ltd) as a photosensitive resin layer. The SU-8 is applied on the conductive layer so as to form a photosensitive resin layer 125 micrometers thick. The photosensitive resin layer is soft-baked at 95 degrees Celsius for 10 minutes. Next, the photosensitive resin layer is exposed to ultraviolet light through a photomask with a mask aligner “MPA600” (product name) manufactured by CANON KABUSHIKI KAISHA. After exposure, the photosensitive resin layer is baked at 65 degrees Celsius for 5 minutes. A latent image of such a pattern that dots 10 micrometers in diameter are disposed two-dimensionally at a pitch of 20 micrometers is formed in the photosensitive resin layer in a regular octagonal region 29.4 mm on a side. The center of gravity of the regular octagonal region coincides with the center of gravity of the silicon substrate. Next, the latent image is developed with SU-8 developer (manufactured by KAYAKU Micro Chemical Co., Ltd). Part of the photosensitive resin layer that is not exposed to the ultraviolet light is dissolved in the developer, and a photosensitive resin layer 125 micrometers in height having such a pattern that dots 10 micrometers in diameter are disposed two-dimensionally at a pitch of 20 micrometers is formed. After developing, the photosensitive resin layer is rinsed with isopropyl alcohol, and is then dried by blowing nitrogen gas. Subsequently, the photosensitive resin is cured by heating the substrate at 200 degrees Celsius for an hour. In this example, this is used as a mold.

In this example, gold is used as metal filling the mold. Using gold plating solution

MICROFAB Aul101 (manufactured by Electroplating Engineers of Japan Ltd.), a gold plated layer having a tensile stress of 100 MPa is formed. The mold is immersed in a gold plating solution, and energization is performed at 60 degrees Celsius at a current density of 0.2 A/dm2 for 24 hours to form a gold plated layer to a height of 120 micrometers from the bottoms of the recesses. Next, the mold is immersed in a mixed aqueous solution of concentrated sulfuric acid and hydrogen peroxide solution to remove the photosensitive resin and the exposed conductive layer. Thus, such a microstructure that a grating made of gold is formed on a silicon substrate is made. The grating made of gold is formed in a regular octagonal region 29 4 mm on a side on the silicon substrate.

In the microstructure of this example, the maximum and minimum values of the distance between the center of gravity of the grating region and the outer edge of the grating region are 38.3 mm and 35 mm, respectively. Therefore, the maximum value of the distance between the center of gravity of the grating region and the outer edge of the grating region is 1.09 times the minimum value. The amount of warping at a point 25 mm distant from the center of gravity of the grating region, in such a direction that the distance from the center of gravity of the grating region to the outer edge of the grating region is maximum, is 233.67 micrometers. On the other hand, the amount of warping at a point 25 mm distant from the center of gravity of the grating region, in such a direction that the distance from the center of gravity of the grating region to the outer edge of the grating region is minimum, is 233.98 micrometers. The difference in the amount of warping at a point 25 mm from the center of gravity between the direction of the maximum value and the direction of the minimum value is less than or equal to 1 micrometer. This difference in the amount of warping is less than or equal to 1% of the maximum amount of warping (233.98 micrometers) at a point 25 mm distant from the center of gravity of the grating region.

### Example 4

This example is a microstructure having a grating region whose outer edge is a square 50 mm on a side having rounded corners as shown in FIG. 5, and is made by the same method as example 1.

In the microstructure of this example, the maximum and minimum values of the distance between the center of gravity of the grating region and the outer edge of the grating region are 34.75 mm and 25 mm, respectively. Therefore, the maximum value of the distance between the center of gravity of the grating region and the outer edge of the grating region is 1.39 times the minimum value. The amount of warping at a point 25 mm distant from the center of gravity of the grating region, in such a direction that the distance from the center of gravity of the grating region to the outer edge of the grating region is maximum, is 148 micrometers. On the other hand, the amount of warping at a point 25 mm distant from the center of gravity of the grating region, in such a direction that the distance from the center of gravity of the grating region to the outer edge of the grating region is minimum, is 164 micrometers. The difference in the amount of warping at a point 25 mm from the center of gravity between the direction of the maximum value and the direction of the minimum value is 16 micrometers. This difference in the amount of warping is about 10% of the maximum amount of warping (164 micrometers) at a point 25 mm distant from the center of gravity of the grating region.

### Example 5

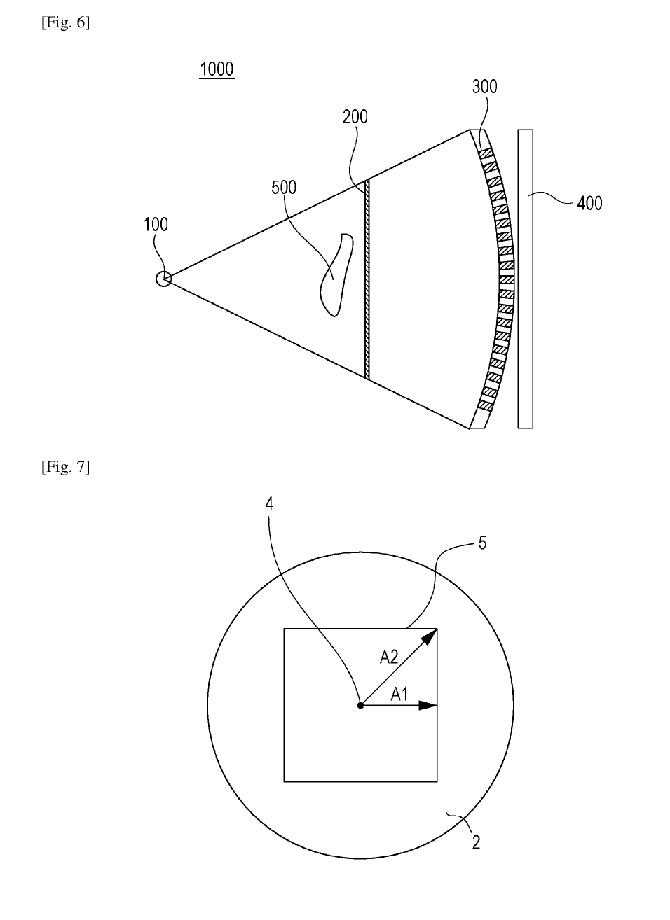

Next, an imaging apparatus that employs a microstructure made in the above-described embodiment or any one of the above-described examples as an X-ray shield grating will be described with reference to FIG. 6.

The imaging apparatus of this example is an imaging apparatus using the X-ray Talbot interferometry. The imaging apparatus 1000 includes an X-ray source 100 that emits spatially coherent divergent X-rays, a diffraction grating 200 that diffracts X-rays, a shield grating 300 in which X-ray shielding portions and X-ray transmitting portions are arranged, and a detector 400 that detects X-rays. The diffraction grating 200 diffracts X-rays from the X-ray source 100, thereby forming an interference pattern. The shield grating 300 shields against some of the X-rays forming this interference pattern. The shield grating 300 is a microstructure according to the above-described embodiment or any one of the above-described examples.

When a subject 500 is disposed between the X-ray source 100 and the diffraction grating 200, an interference pattern having information on the phase shift of X-rays due to the subject 500 is formed. Moire is formed by this interference pattern and the shield grating 300. The information on this moire is detected with the detector.

That is to say, this imaging apparatus 1000 images the subject 500 by detecting the moire having phase information of the subject 500 with the detector. By performing phase retrieval on the basis of this detection result using the Fourier transform method, phase shift method, or the like, a phase image of the subject 500 can be obtained. The grating region of the shield grating 300 includes a region of the detector where X-rays are detected (range of detection).

Although preferred embodiments of the present invention have been described, the present invention is not limited to these embodiments. Various modifications and changes may be made without departing from the spirit of the present invention. Although in the embodiment a grating having a two-dimensional array has been mainly described, the present invention can be applied to an X-ray shield grating having a one-dimensional array used for two-dimensionally divergent X-rays because such a grating is desirably concentrically curved.

Furthermore, the technical elements described herein or illustrated in the drawings exert technical utility separately or in combination, and are not limited to a combination of claims as originally filed. Moreover, the techniques described herein or illustrated by way of example in the drawings are intended to simultaneously achieve a plurality of purposes, and have technical utility by achieving one of the purposes.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-268215, filed Dec. 7, 2011, which is hereby incorporated by reference herein in its entirety.

### REFERENCE SIGNS LIST

1 Microstructure

2 Substrate

3 Grating

4 Center of gravity of grating

5 Outer edge of grating region

6 Outer edge of substrate

1. A microstructure comprising:
a substrate; and
a grating provided in the substrate and made of metal,
wherein the grating is provided with a plurality of holes, the plurality of holes are arranged in a first direction, and in a plane containing the first direction, the maximum value of the distance between the center of gravity of a grating region composed of the grating and the plurality of holes and the outer edge of the grating region is more than 1.00 times and less than 1.39 times the minimum value of the distance between the center of gravity of the grating region and the outer edge of the grating region.

2. The microstructure according to claim 1, wherein in the plane, the maximum value of the distance between the center of gravity of the grating region and the outer edge of the grating region is less than 1.33 times the minimum value of the distance between the center of gravity of the grating region and the outer edge of the grating region.

3. The microstructure according to claim 1, wherein in the plane, the maximum value of the distance between the center of gravity of the grating region and the outer edge of the grating region is less than 1.25 times the minimum value of the distance between the center of gravity of the grating region and the outer edge of the grating region.

4. (canceled)

5. The microstructure according to claim 1, wherein the plurality of holes are arranged in the first direction and a second direction intersecting with the first direction, and the plane contains the first direction and the second direction.

6. The microstructure according to claim 1, wherein in the plane, the outer edge of the substrate and the outer edge of the grating region are similar to each other.

7. The microstructure according to claim 1, wherein in the plane, the center of gravity of the substrate coincides with the center of gravity of the grating region.

8. The microstructure according to claim 1, wherein the microstructure is used as a shield grating that shields against some of divergent X-rays from an X-ray source.

9. The microstructure according to claim 8, wherein the aspect ratio of shielding portions that shield against the divergent X-rays is 5 or more.

10. The microstructure according to claim 1, wherein of the microstructure, at least the grating is concentrically curved.

11. An X-ray imaging apparatus that images a subject, the apparatus comprising:
a diffraction grating that diffracts divergent X-rays from an X-ray source and thereby forms an interference pattern;
a shield grating that shields against some of X-rays forming the interference pattern; and
a detector that detects X-rays passing through the shield grating,
wherein the shield grating has the microstructure according to claim 1.
